(19) United States
(12) Patent Application Publication
(10) Pub. No.: US 2009/0259531 A1
(43) Pub. Date: Oct. 15, 2009

(54) INTERACTIVE ADVERTISEMENTS

(75) Inventors: Roelof Van Zwol, Badalona (ES); Lluis Garcia Pueyo, Sant Cugat del Valles (ES)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/101,469

(22) Filed: Apr. 11, 2008

(51) Int. Cl. G06Q 30/00

(52) U.S. Cl. 705/14

(57) ABSTRACT

A system and method for providing interactive advertisements and collecting data for an advertiser includes a processor, a storage unit in communication with the processor, and a memory unit in communication with the processor, wherein the memory unit contains instructions. The instructions configure the processor to upload sequential media to a central server, wherein the sequential media is an advertisement, provide at least one tag, wherein the at least one tag is a keyword related to a subject matter of the sequential media, and provide the sequential media to a game player via a web portal, wherein the web portal includes a input area for entering words from the game player related to the subject matter of the sequential media.

### BACKGROUND OF THE INVENTION

1. Field of the Invention

The invention relates to Internet based advertisements and more specifically to interactive Internet based advertisements.

2. Description of the Known Technology

Internet based advertisements are fairly common place. In the past, Internet based advertisements generally included graphical advertisements such as banner advertisements or text based advertisements located within a webpage.

Another form of internet based advertisement is sequential media, such as videos. These types of advertisements are similar to television commercials; however, the sequential media containing the advertisements are displayed in a portion of a webpage. One drawback to using sequential media is that sequential media is generally broadcast for a period of time generally lasting fifteen seconds to thirty seconds. During this time, it is very common for viewers to simply ignore the advertisement by viewing something else, such as another webpage, or turning the volume off. Therefore, it remains unclear whether the user is actually watching the advertisement or is simultaneously performing a different task, a task which dominates the attention of the user.

One way of increasing the likelihood that the user will pay attention to the sequential media is to target the user with sequential media that will be of interest to the user. As it is well known in the art, there is a variety of different ways to better target the user with an advertisement that will more likely interest the user. However, even if the user is successfully targeted, the advertisement may not effectively be transmitting the intended message. For example, the user may think that the commercial is selling one type of product when in actuality the commercial is selling another type of product.

### BRIEF SUMMARY OF THE INVENTION

In overcoming the drawbacks of the prior art, a system and method for providing interactive advertisements and collecting data for an advertiser includes a processor, a storage unit in communication with the processor, and a memory unit in communication with the processor. The memory unit contains instructions that configure the processor to upload sequential media to a central server, wherein the sequential media is an advertisement and provides at least one tag, wherein the at least one tag is a keyword related to a subject matter of the sequential media. Thereafter, the sequential media is provided to a game player via a web portal, wherein the web portal includes an input area for entering words from the game player related to the subject matter of the sequential media.

As the game player enters words relating the sequential media, a determination is made if the words entered by the game player match the tags. If there is a match, the game player's score will increase. The score may be based on a variety of factors, including if a tag is matched and on the timing in which the game player enters the words. For example, the tag for the advertisement may be time stamped with a time period. If the player enters a word matching the tag during the appropriate time period, the game player's score could be enhanced. As more and more game players view the advertisement and enter words with the intent of matching tags previously entered by the advertiser, a significant amount of data relating to the advertisement can be obtained. This data can then be provided to the advertiser so as to assist the advertiser in gauging the effectiveness of the advertisement.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram illustrating a system for providing interactive advertisements and collecting data for an advertiser;

FIG. 2 is a block diagram of a central server for the system of FIG. 1;

FIG. 3 is a screen shot of a login window of the system;

FIG. 4 is a screen shot of a user interface of the system;

FIG. 5 is a screen shot of the interactive advertisement of the system; and

FIG. 6 is another screen shot of the interactive advertisement of the system.

### DETAILED DESCRIPTION OF THE INVENTION

Referring to FIG. 1, a system 10 for providing interactive advertisements and collecting data for an advertiser is shown. The system 10 includes a central server 12, an advertiser computer 14, and a game player computer 16. The advertiser computer 14 and the game player computer 16 are each in communication with the central server 12 via a distributed network 18, such as the Internet. The communication may be over a wire line connection or a wireless connection. However, it should be understood that the advertiser computer 14 and/or the game player 16 may communicate with the central server 12 via any other type of network such as a local area network or a wide area network.

The advertiser computer 14 and the game player computer 16 are preferably general purpose computers; however, it should be understood that the advertiser computer 14 and/or the game player computer 16 may be dedicated devices. The advertiser computer 14 generally includes a display 20 having a display area 22. The advertiser computer 14 can therefore display text and graphics in the display area 22 of the display 20. For example, a user interface 28 may be displayed in the display area 22 of the display 20. Generally, this user interface 28 is through a web browser and allows the user of the advertising computer 14 to interact with the central server 12. From this point forward in this specification, the user of the advertising computer 14 will be referred to as the “advertiser.”

The advertiser computer 14 also includes input devices. These input devices generally include, but are not limited to, a keyboard 24 and a mouse 26. The advertiser computer 14 also contains a network interface capable of connecting the advertiser computer 14 with the distributed network 18, allowing the advertiser computer 14 access to other servers, such as the central server 12.

Like the advertising computer, the game player computer 16 generally includes a display 30 having a display area 32. The game player computer 16 can therefore display text and graphics in the display area 32 of the display 30. For example, a user interface 38 may be displayed in the display area 32 of the display 30. Generally, this user interface 38 is through a web browser and allows the user of the game player computer 16 to interact with the central server 12. From this point forward in this specification, the user of the game player computer 16 will be referred to as the “game player.”

The game player computer 16 also includes input devices. These input devices generally include, but are not limited to, a keyboard 34 and a mouse 36. The game player computer 16 also contains a network interface capable of connecting the game player computer 16 with the distributed network 18, allowing the game player computer 16 access to other servers, such as the central server 12.

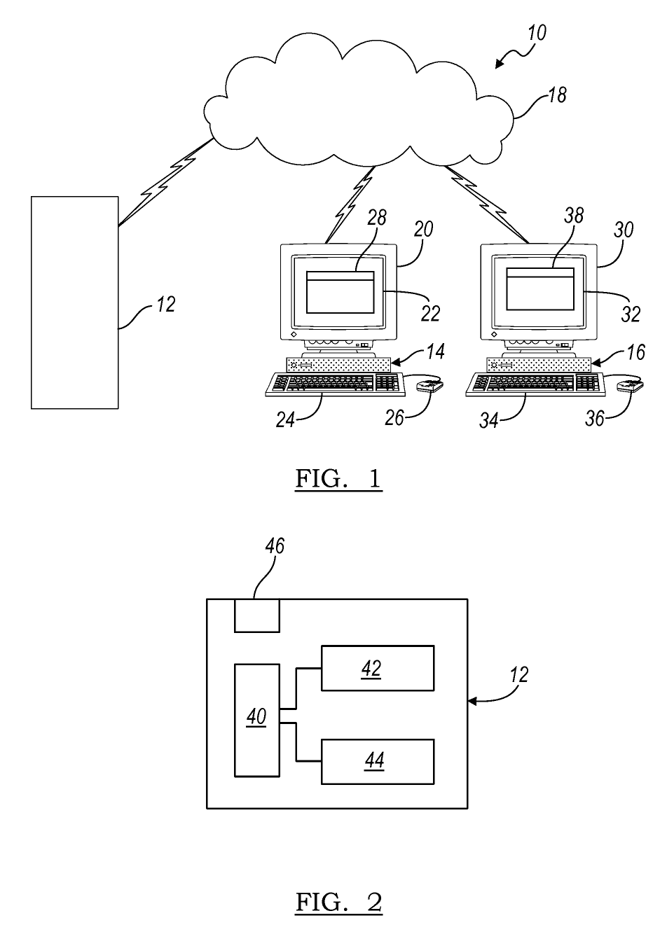

Referring to FIG. 2, a more detailed block diagram of the central server 12 is shown. The central server 12 includes a processor 40 in communication with a memory unit 42 and a storage device 44. The memory unit 42 contains processor executable instructions for configuring the processor to run a variety of different tasks, including those that would be later described in this detailed description section.

The storage device 44 is a storage device for storing data either temporarily or permanently. The storage device 44 may be any storage device known in the art including, but not limited to, magnetic storage devices, such as hard disks, optical storage devices, or solid state storage devices. The processor 40 is also in communication with a network interface 46. The network 46 allows the processor 40 to be in communication with the distributed network 18 of FIG. 1. By so doing, the central server 12 can communicate with the advertiser computer 14 and/or game player computer 16.

Of course, it should be understood that this is only one possible embodiment of the central server 12. The central server 12 can be configured in a variety of different ways as is known in the art. Also, the central server 12 may represent a plurality of servers.

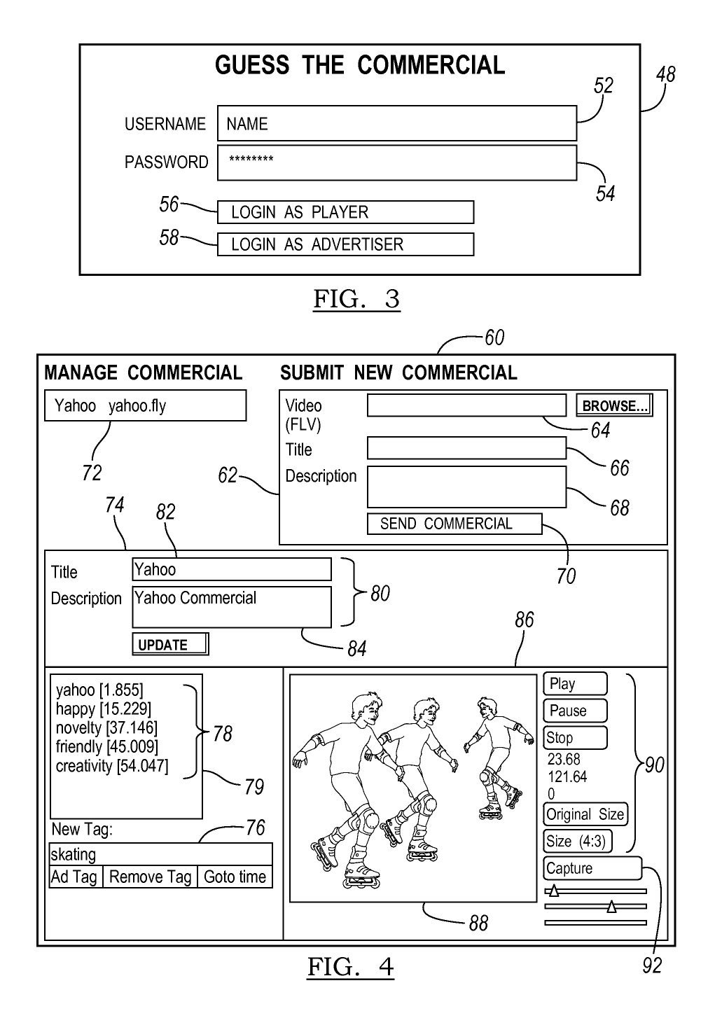

Referring to FIG. 3, a screen shot of a login screen 48 is shown. As will be described later in this specification, the invention relates to a system and method for providing interactive advertisements and for collecting data for an advertiser. To provide interactive advertisements and/or collect data for an advertiser, the advertiser and game player must first login. The login screen 48 includes a user name portion 52 and a password portion 54. In the user name portion 52, the user, either an advertiser or a game player, enters his user name. After entering in his user name, the advertiser or game player enters in his password in the password portion 54. Thereafter, if the user is a game player, the game player will select icon 56 which allows the user to login as a game player. Conversely, if the user is an advertiser, the advertiser will select icon 58 which allows them to login as an advertiser. Of course, it should be understood that the login screen 48 may be configured so as to only allow either the game player to login or the advertiser. In other words, there may be separate web sites and separate login screens, one dedicated for game players and another dedicated for advertisers.

Referring to FIG. 4, a management interface 60 is shown. The advertiser management interface 60 is shown when an advertiser logs in via the previously discussed login screen of FIG. 3. Here, the management interface 60 allows advertisers to upload sequential media, such as internet based advertisements. The management interface 60 is displayed in the displayer area 22 of the display 20 of FIG. 1. The management interface 60 may be a web based interface provided via a web browser, but may also be a dedicated program.

The management interface 60 includes a submitting area 62, wherein the advertiser can upload advertisements. The submitting area 62 includes a file location portion 64, wherein the advertiser can select the file containing the advertisement. Below the file entry area 64 is a title entry area 66 and a description entry area 68. The title entry area 66 allows the advertiser to title the uploaded (or soon to be uploaded) advertisement while the description entry area 68 allows the advertiser to provide a description of the advertisement. Advertisers may enter a web site in the description entry area 68 so that a game player viewing the advertisement will be able to identify the web site which is related to the advertisement so they can obtain more information. Once the areas 64, 66, and 68 have been entered, the advertiser can then submit the commercial by selecting an icon 70.

Once the advertisement has been uploaded, the advertiser can select the advertisement using the advertisement selection area 72. The advertisement selection area 72 may contain a list of advertisements uploaded by the advertiser. The advertiser can simply select the title or the file name of the advertisement to be tagged. The tagging the advertisements will be explained below.

Below the submitting area 62 is a tagging portion 74, which allows the advertiser to add at least one tag related to the uploaded advertisement. The at least one tag is a keyword related to the subject matter of the advertisement. Tags can be added to the advertisement in a tag entry area 76. A list of the tags 78 will then be displayed in a tag display area 79. These tags may be given a priority by the advertiser, the priority indicating the importance of the tag as it relates to the subject matter of the advertisement. Additionally, the advertiser may also time stamp the tags. For example, the list of tags 78 shows a plurality of different tags followed by numbers enclosed in brackets. The numbers enclosed in brackets indicate a time period of the tag that relates to a moment within the advertisement wherein the subject matter of the advertisement relates to the tag. As it is well known, it is not uncommon for advertisements to contain multiple messages at different times during the advertisement. By time stamping the tags, advertisers can identify the time periods messages are intended to be communicated to game players.

The tagging portion 74 also includes a title and description update area 80. The title and description update area 80 includes a text entry box 82 for entering an updated title and a text entry box 84 for updated the description of the advertisement. The title and description update area 80 is functionally similar to the title entry area 66 and the description entry area 68.

The advertiser management interface 60 also includes a video playback area 86. The video playback area 86 includes a display area 88 for displaying the advertisement as well as a control area 90 containing a variety of controls for controlling the advertisement. Additionally, the control area 90 includes a capture icon 92 that can be used to define a moment in time that can later be tagged with a keyword. For example, the advertiser can use the controls in the control area 90 to play the advertisement to a certain point in time, wherein the advertiser can then simply click on the capture icon 92 and enter in a tag in the tag entry area 76. Once this is done, a time stamped tag will be created.

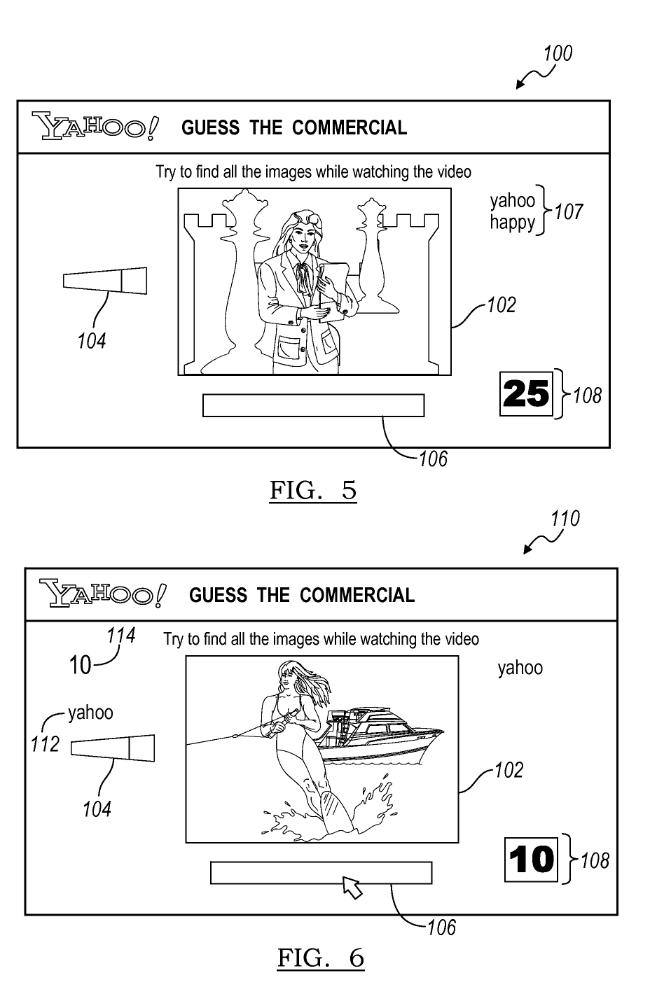

Referring to FIG. 5, a screen shot of the game play interface 100 is shown. The game play interface 100 is displayed in the displayer area 32 of the display 30 of FIG. 1. The game play interface 100 may be a web based interface provided via a web browser, but may also be a dedicated program.

The game play interface 100 includes a display area 102 for displaying the previously uploaded advertisement. The interface 100 also includes a volume control 104 for controlling the volume of the advertisement as well as a text entry box 106. As the game player views the advertisement, the game player can enter words in text entry box 106 that relate to the subject matter of the advertisement in an attempt to guess the tags that were previously entered by the advertiser. As the game player correctly enters words that correspond to tags provided by the advertiser, the correctly guessed words will be displayed in a portion 106 of the interface 100.

Additionally, the interface 100 also includes a score area 108 that provides the game player with a score based upon their guesses entered into the text box 106. As the game player correctly guesses the tags relating to the advertisement, the score will generally increase. Additionally, as stated previously, it is possible for the advertiser to prioritize the tags as well as time stamp the tags. The score provided to the game player may be adjusted to provide more points to tags that are prioritized and/or to provide more points to correctly guessing the tag during the time period indicated by the time stamp.

Referring to FIG. 6, another embodiment of the game player interface 110 is shown. This interface 1 10 is similar to the interface 100 shown in FIG. 5 and so like reference numbers are used to refer to like elements. This embodiment differs from that of FIG. 5 in that this embodiment also momentarily shows the word entered by the game player in the text box 106 at location 112. The word entered into the text box 106 and shown at the location 112 is only shown for a short period of time, so that the game player can see what was entered into the text box 106. If the word displayed in the display area 112 matches one of the tags, a score relating to the word displayed in location 112 will be displayed in location 114 and added to the total score displayed at location 108. Afterwards, the game player is presented with title and description of the advertisement once the game has finished, thus allowing him access to the advertisers web-site, etc.

As more and more game players view the advertisement and enter words with the hope of matching tags previously entered in by the advertiser, a significant amount of data relating to the advertisement can be obtained and stored on the storage device 44 of the central sever 12. This data can then be provided to the advertiser. This would allow the advertiser to see statistics for each of the advertisement that have been viewed by game players.

Numerous different statistics can be compiled based upon the game play of the game players. These statistics can include the number of games played involving the advertisement, the average number of words entered in by the game player, the number of times the words entered by the game player match a tag, the period of time which the words entered by the game player, and words entered by the game player that did not match the at least one tag.

By providing this data to an advertiser, advertisers can better determine if the sequential media containing the advertisement is communicating its intended message. For example, if the words entered by the game players generally match the tags provided by the advertiser, the advertiser can safely conclude that the advertisement is communicating its intended message. However, if the key words entered by the game players differ from the tags entered by the advertiser, the advertiser may conclude that the advertisement is not communicating its intended message. This allows the advertiser to either scrap the commercial or modify the commercial to better communicate its intended message.

Additionally, by providing information as to when key words were entered by game players, the advertiser can determine the effectiveness of the advertisement over the time span in which the advertisement is played. For example, if one type of message is to be communicated in the first half of the advertisement and a second type of message is to be communicated in the second half of the advertisement, the advertiser can view the times in which words were entered by the game players and determine if those separate messages are being properly communicated. If not, the advertiser can modify the advertisement such that the message is more effectively communicated.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A method for providing interactive advertisements, the method comprising the steps of:
receiving sequential media from an advertiser, wherein the sequential media is an advertisement;
providing at least one tag, wherein the at least one tag is a keyword related to a subject matter of the sequential media; and
providing the sequential media to a game player via a web portal, wherein the web portal includes a input area for entering words from the game player related to the subject matter of the sequential media.

2. The method of claim 1, further comprising the step of prioritizing the at least one tag.

3. The method of claim 1, further comprising the step of time stamping the at least one tag with a time period, wherein the time period of the tag relates to a moment within the sequential media wherein the subject matter of the sequential media relates to the at least one tag.

4. The method of claim 1, further comprising the steps of:
prioritizing the at least one tag; and
time stamping the at least one tag with a time period, wherein the time period of the tag relates to a moment within the sequential media wherein the subject matter of the sequential media relates to the at least one tag.

5. The method of claim 1, further comprising the steps of:
providing a description relating the subject matter of the sequential media; and
providing the description to the game player when the sequential media has finished playing.

6. The method of claim 5, wherein the description is linked to a website related to the sequential media.

7. A method for collecting data for an advertiser, the method comprising the steps of:
providing sequential media to a game player via a game player interface;
wherein the sequential media comprises an advertisement and has at least one tag associated with the sequential media, the at least one tag being a keyword related to a subject matter of the sequential media;
wherein the game player interface includes an input area for entering words from the game player;
storing words entered by the game player in the input area;
determining if the words entered by the game player are the same as the at least one tag;
providing a score to the game player, wherein the score is based upon if the words entered by the game player in the input area are the same as the at least one tag.

8. The method of claim 7, wherein the score is based upon a priority given to the at least one tag.

9. The method of claim 7, wherein:
the at least one tag is time stamped with a time period, wherein the time period of the at least one tag relates to a moment within the sequential media wherein the subject matter of the sequential media relates to the at least one tag; and
the score is based upon if the words entered by the game player in the input area are the same as the at least one tag and the words entered by the game player occurred during the time period.

10. The method of claim 7, wherein:
the at least one tag is time stamped with a time period, wherein the time period of the at least one tag relates to a moment within the sequential media wherein the subject matter of the sequential media relates to the at least one tag;
the score is based upon a priority given to the at least one tag and if the words entered by the game player in the input area are the same as the at least one tag and the words entered by the game player occurred during the time period of the at least one tag.

11. The method of claim 7, further comprising the steps of:
compiling statistics based upon the game play of the game player; and
providing the statistics to the advertiser.

12. The method of claim 11, wherein the statistics comprise at least one of the following:
number of games played involving the sequential media;
average number of terms involving the sequential media typed by the game player;
number of times the words entered by the game player matched the at least one tag;
period of time of which the words were entered by the game player; and
words entered by the game player that did not match the at least one tag.

13. A system for providing interactive advertisements, the system comprising:
a processor;
a storage unit in communication with the processor;
a memory unit in communication with the processor, wherein the memory unit contains instructions, the instructions configure the processor to:
receive sequential media from an advertiser, wherein the sequential media is an advertisement;
provide at least one tag, wherein the at least one tag is a keyword related to a subject matter of the sequential media; and
provide the sequential media to a game player via a web portal, wherein the web portal includes a input area for entering words from the game player related to the subject matter of the sequential media.

14. The system of claim 13, wherein the instructions further configure the processor to prioritize the at least one tag.

15. The system of claim 13, wherein the instructions further configure the processor to time stamp the at least one tag with a time period, wherein the time period of the tag relates to a moment within the sequential media wherein the subject matter of the sequential media relates to the at least one tag.

16. The system of claim 13, wherein the instructions further configure the processor to:
prioritize the at least one tag; and
time stamp the at least one tag with a time period, wherein the time period of the tag relates to a moment within the sequential media wherein the subject matter of the sequential media relates to the at least one tag.

17. The system of claim 13, wherein the instructions further configure the processor to:
provide a description relating the subject matter of the sequential media; and
provide the description to the game player when the sequential media has finished playing.

18. The system of claim 17, wherein the description is link to a website related to the sequential media.

19. A system for collecting data for an advertiser, the system comprising:
a processor;
a storage unit in communication with the processor;
a memory unit in communication with the processor, wherein the memory unit contains instructions, the instructions configure the processor to:
provide sequential media to a game player via a game player interface;
wherein the sequential media is an advertisement and has at least one tag associated with the sequential media, the at least one tag being a keyword related to a subject matter of the sequential media;
wherein the game player interface includes a input area for entering words from the game player;
store words entered by the game player in the input area on the storage device;
determine if the words entered by the game player are the same as the at least one tag;
provide a score to the game player, wherein the score is based upon if the words entered by the game player in the input area are the same as the at least one tag.

20. The system of claim 19, wherein the score is based upon a priority given to the at least one tag.

21. The system of claim 19, wherein:
the at least one tag is time stamped with a time period, wherein the time period of the at least one tag relates to a moment within the sequential media wherein the subject matter of the sequential media relates to the at least one tag; and
the score is based upon if the words entered by the game player in the input area are the same as the at least one tag and the words entered by the game player occurred during the time period.

22. The system of claim 19, wherein:
the at least one tag is time stamped with a time period, wherein the time period of the at least one tag relates to a moment within the sequential media wherein the subject matter of the sequential media relates to the at least one tag;
the score is based upon a priority given to the at least one tag and if the words entered by the game player in the input area are the same as the at least one tag and the words entered by the game player occurred during the time period of the at least one tag.

23. The system of claim 19, wherein the instructions further configure the processor to:
compile statistics based upon the game play of the game player; and
provide the statistics to the advertiser.

24. The system of claim 23, wherein the statistics comprise at least one of the following:
number of games played involving the sequential media;
average number of terms involving the sequential media typed by the game player;
number of times the words entered by the game player matched the at least one tag;
period of time of which the words were entered by the game player; and
words entered by the game player that did not match the at least one tag
